(19) United States
(12) Patent Application Publication
(10) Pub. No.: US 2020/0256097 A1
(43) Pub. Date: Aug. 13, 2020

(54) DOOR CHECK APPARATUS FOR VEHICLE

(71) Applicant: AISIN SEIKI KABUSHIKI KAISHA, Kariya-shi (JP)

(72) Inventors: Takayuki UENO, Kariya-shi (JP); Motohiko HIROSE, Kariya-shi (JP); Hirokazu SUZUMURA, Kariya-shi (JP)

(73) Assignee: AISIN SEIKI KABUSHIKI KAISHA, Kariya-shi (JP)

(21) Appl. No.: 16/788,969

(22) Filed: Feb. 12, 2020

(30) Foreign Application Priority Data
Feb. 13, 2019 (JP) 2019-023260

(51) Int. Cl. E05C 17/20

(52) U.S. Cl. CPC E05C 17/203; E05Y 2600/41; E05Y 2900/531; E05Y 2600/626; E05Y 2201/258; E05Y 2600/46

(57) ABSTRACT

A door check apparatus for a vehicle includes a first tubular member connected to a vehicle body to be pivotable relative to the vehicle body, a second tubular member movable relative to the first tubular member in an axial direction, a bracket connecting the second tubular member to a swing door in such a manner that the second tubular member is pivotable relative to the swing door, the second tubular member including a pair of engagement protrusions forming a pivot shaft of the second tubular member, the bracket including a pair of support walls including engagement holes engaging with the engagement protrusions, and at least one of the support walls being provided with an opening portion allowing the engagement protrusion to be inserted into the engagement hole and a closing member closing the opening portion in a state where the engagement protrusion is inserted in the engagement hole.

### CROSS REFERENCE TO RELATED APPLICATIONS

This application is based on and claims priority under 35 U.S.C. § 119 to Japanese Patent Application 2019-023260, filed on Feb. 13, 2019, the entire content of which is incorporated herein by reference.

### TECHNICAL FIELD

This disclosure generally relates to a door check apparatus for a vehicle.

### BACKGROUND DISCUSSION

Conventionally, a door check apparatus that can apply a braking force to a swing door of a vehicle is known. For example, a door check apparatus described in US Patent application publication No. 2017/0350175A1 (which will be referred to also as Patent reference 1) includes a first tubular member connected to a vehicle body to be pivotable relative to the vehicle body and a second tubular member arranged to be coaxial with the first tubular member in a state of being relatively movable in an axial direction. The known door check apparatus further includes a spindle screw rotatably supported by a bearing provided at the second tubular member, in a state of being arranged inside the second tubular member to be coaxial with the first tubular member and the second tubular member, and a spindle nut fixed to the first tubular member not to be rotatable relative to the first tubular member in a state where the spindle nut is threadedly engaged with the spindle screw. The known door check apparatus includes an electromagnetic brake connected to the spindle screw.

That is, according to the known door check apparatus, the first tubular member and the second tubular member move relative to each other in an axial direction in accordance with an opening and closing action of the swing door, and the spindle screw rotates within the tubes of the first tubular member and the second tubular member. The electromagnetic brake applies braking on the rotations of the spindle screw, and thus a braking force is applied to the swing door.

The known door check apparatus of Patent reference 1 further includes a pair of engagement protrusions extending from a peripheral surface of the second tubular member in directions which oppose each other in a state where the engagement protrusions are orthogonal to an axial line of the second tubular member, and a pair of support arms fixed to the swing door and including engagement hole engaging with the engagement protrusions. Accordingly, the second tubular member is configured to be pivotally connected to the swing door in a state where a bending load is not applied to the first tubular member and the second tubular member that move relative to each other in the axial direction and to the spindle nut arranged between the first tubular member and the second tubular member.

In the configuration in which the second tubular member is pivotally connected to the swing door with the use of the two support arms, however, each of the support arms needs to be fixed to the vehicle with accuracy such that an inclination or a twist does not occur to a pivot shaft of the second tubular member, the pivot shaft which is formed of the engagement protrusions engaging with the respective support arms. Further, in the configuration of the above-described known technique, many parts are assembled on the support arms, the parts including a pressing member that is in slidably contact with the first tubular member and a biasing member thereof, for example. Accordingly, assembly work of the door check apparatus is made complicated, and therefore there remains room for improving in this respect.

A need thus exists for a door check apparatus which is not susceptible to the drawback mentioned above.

### SUMMARY

According to an aspect of this disclosure, a door check apparatus for a vehicle includes a first tubular member configured to be connected to a vehicle body to be pivotable relative to the vehicle body, a second tubular member arranged coaxially with the first tubular member in a state where the second tubular member is movable relative to the first tubular member in an axial direction, a bracket configured to connect the second tubular member to a swing door in such a manner that the second tubular member is pivotable relative to the swing door. The second tubular member includes a pair of engagement protrusions, the engagement protrusions are extended in opposing directions in a state where the engagement protrusions are orthogonal to an axial line of the second tubular member, and the engagement protrusions form a pivot shaft of the second tubular member. The bracket includes a pair of support walls provided to oppose each other, the support walls include engagement holes engaging with the engagement protrusions. The bracket includes a connecting wall connecting the support walls to each other. At least one of the support walls is provided with an opening portion allowing one of the engagement protrusions to be inserted into one of the engagement holes from a radial direction of the engagement hole, and a closing member closing the opening portion in a state where the engagement protrusion is inserted in the engagement hole.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a vehicle including swing doors, according to an embodiment disclosed here;

FIG. 2 is a perspective view of the swing door;

FIG. 3 is a front view of a door check apparatus according to the embodiment;

FIG. 4 is a side view of the door check apparatus;

FIG. 5 is an exploded perspective view of the door check apparatus;

FIG. 6 is a cross-sectional view of the door check apparatus taken along line VI-VI in FIG. 4;

FIG. 7 is a cross-sectional view of the door check apparatus taken along line VII-VII in FIG. 3;

FIG. 8 is an enlarged view of the door check apparatus, which illustrates a part of the apparatus in a vicinity of a closing member fixed to a bracket according to the embodiment;

FIG. 9A is a plan view of the bracket;

FIG. 9B is a front view of the bracket;

FIG. 9C is a side view of the bracket;

FIG. 10A is a plan view of the closing member;

FIG. 10B is a front view of the closing member;

FIG. 10C is a side view of the closing member; and

FIG. 11 is an explanation view showing a procedure of assembling the closing member on the bracket.

### DETAILED DESCRIPTION

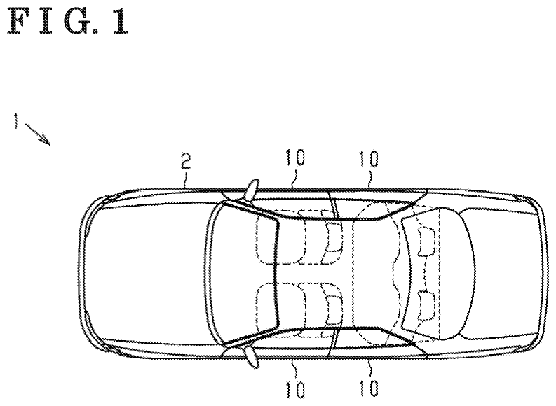

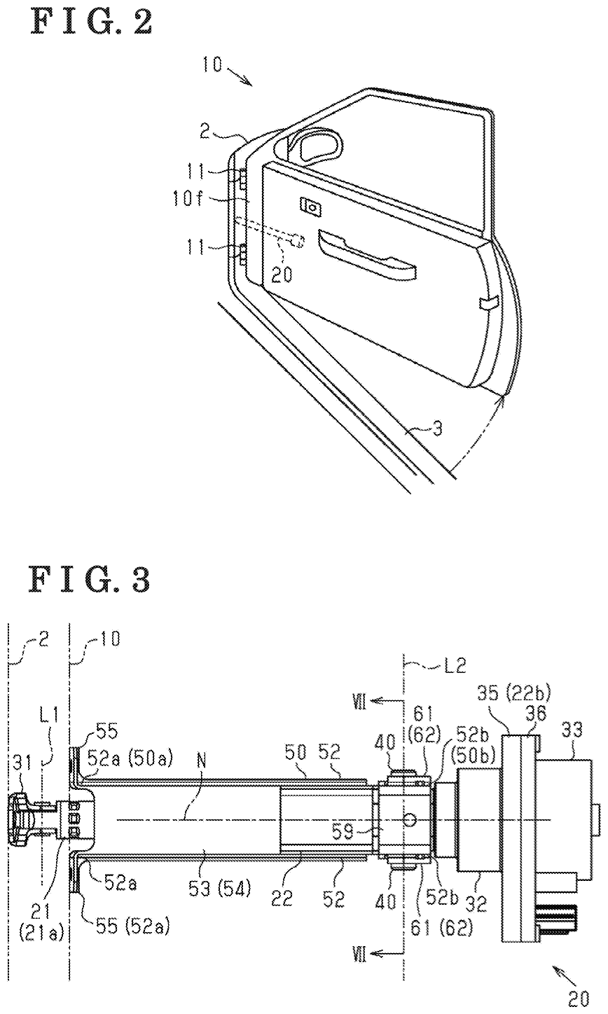

An embodiment of a door check apparatus for a vehicle disclosed here will be explained with reference to the drawings. As illustrated in FIGS. 1 and 2, a vehicle 1 according to the embodiment includes four swing doors 10 each configured to open and close a door opening portion 3 provided at a side surface of a vehicle body 2 of the vehicle 1. Each of the sing doors 10 pivots about a hinge 11 provided at a front end portion 10f of the swing door 10, and the hinge 11 serves as a fulcrum of the swing. The vehicle 1 includes a configuration in which each of the swing doors 10 performs an opening and closing operation at a side of each of seats provided inside a vehicle cabin of the vehicle 1.

As illustrated in FIGS. 2 and 3, the swing door 10 is provided with a door check apparatus 20 including a braking function for applying a braking force to the swing door 10 at which the door check apparatus 20 is provided. Thus, the vehicle 1 is configured in such a manner that the braking is applied to the swing door 10 performing the opening and closing operation, and accordingly an operation position of the swing door 10 is maintained.

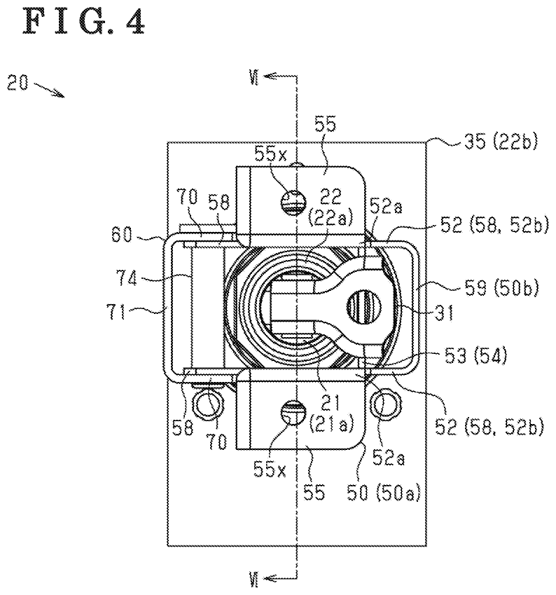

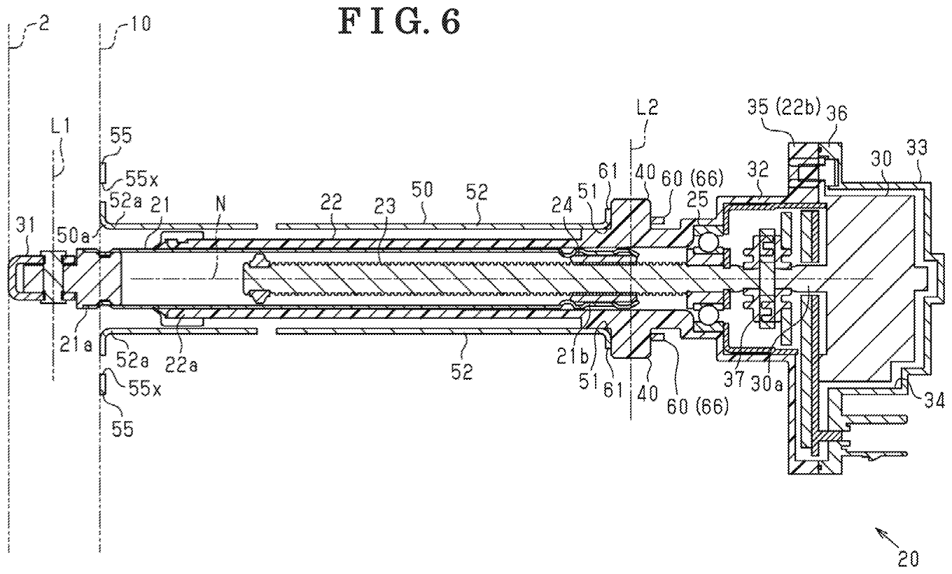

In further detail, as illustrated in FIGS. 3 to 6, the door check apparatus 20 of the embodiment includes an inner tube 21 (i.e., a first tubular member) of which an end portion is connected to the vehicle body 2 to be pivotable relative to the vehicle body 2 and an outer tube 22 (i.e., a second tubular member) connected to the swing door 10 to be pivotable relative to the swing door 10 in a state where the outer tube 22 is arranged around the inner tube 21. In the embodiment, the inner tube 21 of the door check apparatus 20 is formed with the use of metal and the outer tube 22 of the door check apparatus 20 is formed with the use of resin. The door check apparatus 20 of the embodiment includes a spindle screw 23 arranged inside the inner tube 21 and the outer tube 22 to be coaxial with the inner tube 21 and the outer tube 22. The spindle screw 23 is supported by a bearing 25 fixed inside the outer tube 22 in a state where the spindle screw 23 is threadedly engaged with a spindle nut 24 fixed to the inside the inner tube 21. The door check apparatus 20 of the embodiment includes an electromagnetic brake 30 connected to an end portion of the spindle screw 23.

The door check apparatus 20 of the embodiment is configured such that the inner tube 21 and the outer tube 22 are displaced relative to each other in an axial direction thereof in association with the opening and closing operation of the swing door 10. The door check apparatus 20 is configured such that the inner tube 21 and the outer tube 22 are displaced relative to each other and thereby the spindle screw 23 is rotated. The door check apparatus 20 is configured such that the electromagnetic brake 30 retained integrally with the outer tube 22 applies the braking to the rotations of the spindle screw 23, and thereby applying the braking force to the swing door 10.

In further detail, according to the door check apparatus 20 of the embodiment, a connecting member 31 forming a pivot shaft L1 of the inner tube 21 relative to the vehicle body 2 is fixed to a first end portion 21a of the inner tube 21. The spindle nut 24 of the embodiment is fixed to be unrotatable relative to a second end portion 21b of the inner tube 21.

The outer tube 22 of the embodiment retains the bearing 25 inside the outer tube 22, and the bearing 25 is arranged to be close to a second end portion 22b of the outer tube 22 relative to a central position of the outer tube 22 in a lengthwise direction thereof. The outer tube 22 includes a large diameter portion 32 positioned close to the second end portion 22b of the outer tube 22 relative to the bearing 25. According to the door check apparatus 20 of the embodiment, a cover member 33 including a bottomed substantially cylindrical shape is fixed to the large diameter portion 32 provided at the second end portion 22b of the outer tube 22, and accordingly a housing chamber 34 housing therein the electromagnetic brake 30 (i.e., a brake apparatus) is formed.

Specifically, the outer tube 22 of the embodiment includes a flange portion 35 extended from the second end portion 22b of the outer tube 22 in a radial direction of the outer tube 22. Also the cover member 33 includes a flange portion 36 provided at an opening end-side of the cover member 33, the flange portion 36 being similar to the flange portion 35. The door check apparatus 20 of the embodiment is configured such that the flange portions 35 and 36 are fastened or joined to each other, and thus the cover member 33 is fixed to the second end portion 22b of the outer tube 22.

The electromagnetic brake 30 of the door check apparatus 20 of the embodiment is accommodated in the housing chamber 34 formed of the large diameter portion 32 of the outer tube 22 and the cover member 33, to be positioned at a side of the cover member 33. The electromagnetic brake 30 of the embodiment includes a substantially cylindrical shape of which a diameter is slightly smaller than an inner cylindrical shape of the cover member 33. The door check apparatus 20 of the embodiment is configured such that a joint 37 connecting a rotary shaft 30a of the electromagnetic brake 30 and the spindle screw 23 to each other is accommodated in the housing chamber 34, to be positioned at a side of the large diameter portion 32 of the outer tube 22.

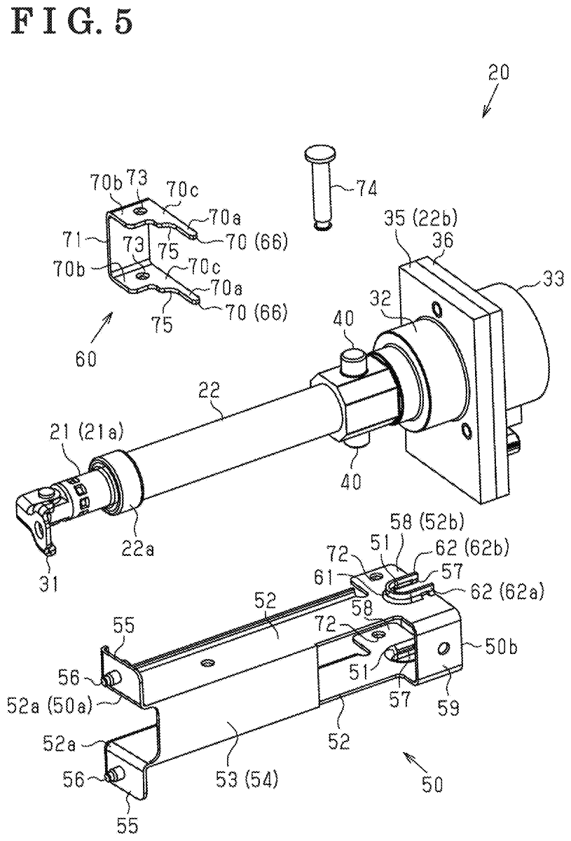

As illustrated in FIGS. 5 to 8, the outer tube 22 of the embodiment includes a pair of engagement protrusions 40, 40. The engagement protrusions 40, 40 are extended in directions which are opposite to each other in a state where the engagement protrusions 40, 40 are arranged to be orthogonal to an axial line N of the outer tube 22. Each of the engagement protrusions 40, 40 is provided at the outer tube 22 to be close to the first end portion 22a relative to the positon at which the bearing 25 is retained inside the outer tube 22. Each of the engagement protrusions 40, 40 includes a substantially cylindrical outer shape protruding from a peripheral surface of the outer tube 22.

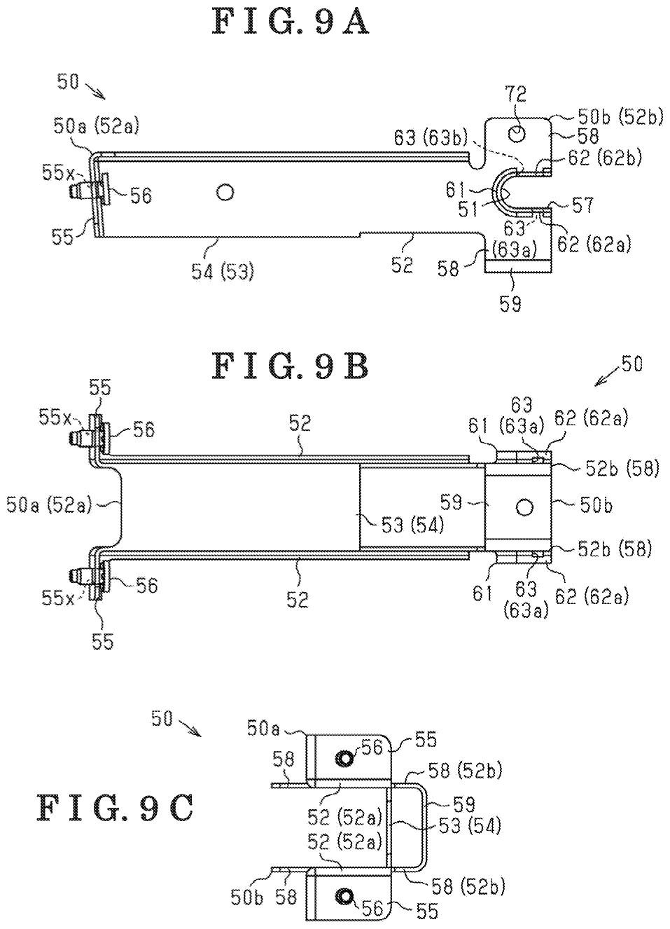

As illustrated in FIGS. 5 to 8 and FIGS. 9A to 9C, the door check apparatus 20 of the embodiment includes a bracket 50 attached to the outer tube 22 in a state where the bracket 50 engages with the engagement protrusions 40, 40. Then, the bracket 50 is fixedly attached to the swing door 10, and thus the outer tube 22 is connected to the swing door 10 in a manner that the outer tube 22 is allowed to pivot relative to the swing door 10 in a state where the engagement protrusions 40, 40 form a pivot shaft L2.

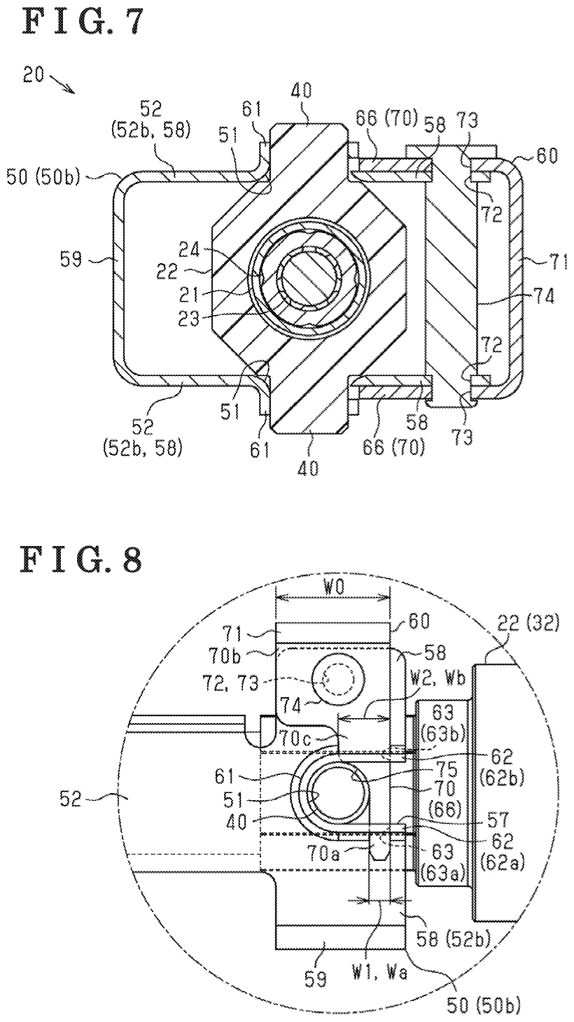

In further detail, the bracket 50 of the embodiment includes a pair of support walls 52, 52. The support walls 52, 52 are arranged to oppose or face each other, and include engagement holes 51, 51 engaging with the engagement protrusions 40, 40, respectively. The bracket 50 includes a connecting wall 53 connecting the support walls 52, 52 to each other. Each of the support walls 52, 52 includes an outer shape formed in an elongated substantially plate shape extended in the axial direction of the outer tube 22. The connecting wall 53 includes an outer shape formed in an elongated substantially plate shape which is shorter than each of the support walls 52, 52. The connecting wall 53 of the bracket 50 connects a width-direction end portion (which is at the left side in FIG. 7) of each of the support walls 52, 52 to each other, at a side at which a first end portion 52a of each of the support walls 52, 52 is positioned.

The bracket 50 of the embodiment includes a U-shaped portion 54 including a cross section of substantially U-shape or three-sided rectangular shape. The U-shaped portion 54 is formed of the support walls 52, 52 and the connecting wall 53, and is positioned at a side of a first end portion 50a of the bracket 50. Each of the support walls 52, 52 of the bracket 50 includes a flange portion 55 formed at the first end portion 52a of the support wall 52. Each of the flange portion 55 includes a fastening hole 55x formed to penetrate the flange portion 55 in a thickness direction. At the door check apparatus 20 of the embodiment, a rivet 56 is inserted into each of the fastening holes 55x, 55x. A portion of the bracket 50, the portion which is positioned at a side of the first end portion 50a, is fixedly fastened to the swing door 10 by the fastening with the use of the rivets 56, 56.

At the bracket 50 of the embodiment, each of the engagement holes 51, 51 to be engaged with the corresponding engagement protrusion 40 of the outer tube 22 is provided at a second end portion 52b of each of the support walls 52, 52. Each of the support walls 52, 52 includes an opening portion 57 including a slit shape which is in communication with the corresponding engagement hole 51. Via the opening portions 57, 57, the engagement protrusions 40, 40 of the outer tube 22 are allowed to be inserted from the radial direction into the engagement holes 51, 51 provided at the support walls 52, 52.

Specifically, at the bracket 50 of the embodiment, each of the opening portions 57, 57 opens in a lengthwise direction of the support walls 52, 52. The second end portions 52b, 52b of the support walls 52, 52 at which the opening portions 57, 57 are provided correspond to wide portions 58, 58 each of which is formed to be wide or broad in a width direction of the support wall 52. The bracket 50 includes a second connecting wall 59 connecting width-direction end portions of the respective wide portions 58, 58 to each other at the same side as the connecting wall 53 is arranged.

As illustrated in FIG. 8, the door check apparatus 20 of the embodiment includes a closing member 60 closing the opening portions 57, 57 that are in communication with the engagement holes 51, 51 in a state where the engagement protrusions 40, 40 of the outer tube 22 are placed by insertion in the engagement holes 51, 51 of the bracket 50. That is, the engagement protrusions 40, 40 inserted inside the engagement holes 51, 51 are restricted by the closing member 60 from performing a relative movement via the opening portions 57, 57. Thus, the door check apparatus 20 of the embodiment is configured such that the outer tube 22 is connected to the bracket 50 not to detach from the bracket 50.

As illustrated in FIG. 3, according to the door check apparatus 20 of the embodiment is, the connecting member 31 provided at the first end portion 21a of the inner tube 21 is fixed to the vehicle body 2 in a state where the pivot shaft or axis L1 of the inner tube 21, the pivot shaft L1 which is formed of the connecting member 31, and the pivot shaft or axis L2 of the outer tube 22, the pivot shaft L2 which is formed of the engagement protrusions 40, 40, are extended in an up and down direction of the vehicle 1. Accordingly, the first end portion 50a of the bracket 50 is configured to be fixed to the swing door 10 in a state where the support walls 52, 52 engaging with the engagement protrusions 40, 40 of the outer tube 22 face each other in the up and down direction.

In more detail, as illustrated in FIGS. 7 to 9C, the bracket 50 of the embodiment includes a peripheral wall portion 61 formed in a standing manner at a peripheral edge of the engagement hole 51 at the second end portion 52b of each of the support walls 52, 52. The door check apparatus 20 is configured such that the peripheral wall portions 61, 61 support, from a radially outer side, the engagement protrusions 40, 40 of the outer tube 22 that are positioned inside the engagement holes 51, 51, and thus the outer tube 22 stably pivots around the pivot shaft L2 formed of the engagement protrusions 40, 40.

Each of the peripheral wall portions 61, 61 of the bracket 50 includes an extended wall 62 provided in an extending manner at a peripheral edge of the opening portion 57 that is in communication with the engagement hole 51. Specifically, the bracket 50 includes a first extended wall 62a and a second extended wall 62b each serving as the extended wall 62. The first extended wall 62a and the second extended wall 62b face or oppose each other in the width direction of the support wall 52 in a manner that the opening portion 57 extended in the slit configuration is interposed or sandwiched between the first extended wall 62a and the second extended wall 62b. The first extended wall 62a and the second extended wall 62b include insertion holes 63a and 63b, respectively. The insertion holes 63a, 63b are provided at positions that face or oppose each other and are formed to penetrate the first extended wall 62a and the second extended wall 62b in thickness directions, respectively. The closing member 60 of the embodiment includes a pair of insertion portions 66, 66. Each of the insertion portions 66, 66 is configured to be inserted into both the insertion holes 63a, 63b, and thus the insertion portion 66 comes to be arranged so as to bridge between the first extended wall 62a and the second extended wall 62b opposing each other across the opening portion 57. Consequently, the bracket 50 of the embodiment includes a configuration in which the insertion portions 66, 66 of the closing member 60 are arranged to extend in the width direction of the support walls 52, 52 and close the opening portions 57, 57 so that the engagement protrusions 40, 40 of the outer tube 22 that are disposed inside the engagement holes 51, 51 do not come out of the engagement holes 51, 51 via the opening portions 57, 57.

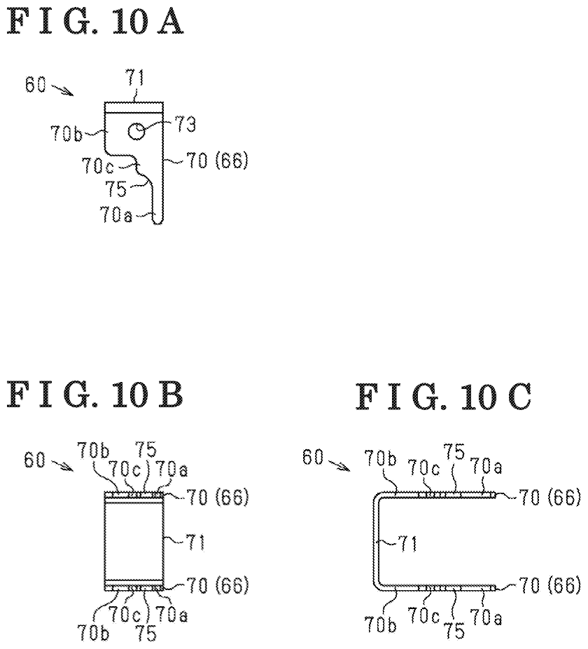

As illustrated in FIGS. 8, 10A to 10C, and 11, an outer shape of the closing member 60 of the embodiment has a cross section of a substantially U-shape or three-sided rectangular shape including side plate portions 70, 70 arranged as a pair to face or oppose each other, and a standing plate portion 71 connecting the side plate portions 70, 70 to each other. According to the door check apparatus 20 of the embodiment, each of the closing member 60 and the bracket 50 is formed by performing plastic working on plate material made of metal. At the closing member 60, each of the side plate portions 70, 70 connected to each other via the standing plate portion 71 includes a base end portion 70b, and each of the base end portions 70b, 70b includes a width W0 which is substantially equal to a width of the standing plate portion 71. Each of the side plate portions 70, 70 includes a distal end portion 70a, and each of the distal end portions 70a, 70a includes a width W1 which is smaller than the width of the base end portion 70b (W0>W1). Each of the side plate portions 70, 70 of the closing member 60 of the embodiment serves as the insertion portion 66 configured to be inserted into the insertion holes 63a and 63b of the first extended wall 62a and the second extended wall 62b that face each other across the opening portion 57 provided at each of the support walls 52, 52 of the bracket 50.

Specifically, as illustrated in FIGS. 8 to 10C, at the bracket 50 of the embodiment, each of the widths of the insertion holes 63a and 63b of the first extended wall 62a and the second extended wall 62b and the width of each of the side plate portions 70, 70 forming the insertion portions 66, 66 of the closing member 60 is converted to a length in the lengthwise direction of the support wall 52. The insertion hole 63a of the first extended wall 62a includes a width Wa which is substantially equal to the width of the distal end portion 70a of each of the side plate portions 70, 70 (Wa≈W1). The first extended wall 62a is formed in a standing manner and the first extended wall 62a is positioned, relative to the opening portion 57, close in the width direction of the support wall 52 to the side at which the support walls 52, 52 are connected to each other with the connecting wall 53 (that is, the lower side in FIG. 8).

At the closing member 60 of the embodiment, each of the side plate portions 70, 70 includes an intermediate portion 70c. Each of the intermediate portions 70c, 70c includes a width W2 which is larger than the width W1 of the distal end portion 70a and smaller than the width W of the base end portion 70b (W1<W2<W0). The insertion hole 63b of the second extended wall 62b opposing the first extended wall 62a includes a width Wb which is substantially equal to the width of the intermediate portion 70c of each of the side plate portions 70, 70 (Wb≈W2).

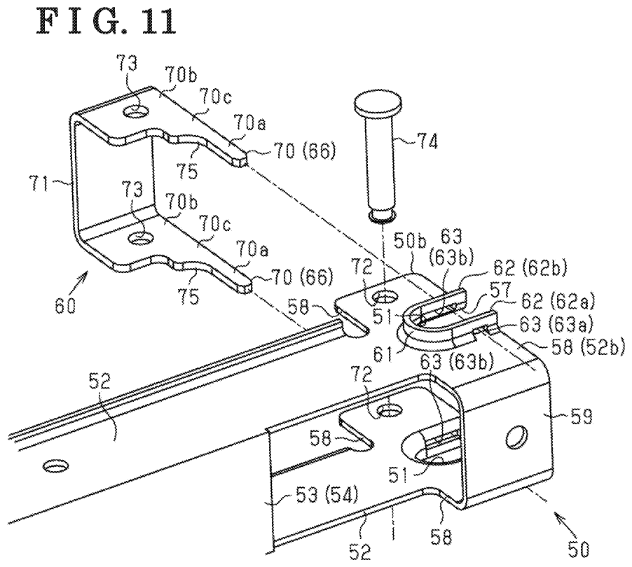

That is, as illustrated in FIGS. 8 and 11, the side plate portions 70, 70 serving as the insertion portions 66, 66 of the closing member 60 are orthogonal to the lengthwise direction (the right and left direction in FIG. 8) of the support walls 52, 52 and are arranged at positions that sandwiching the support walls 52, 52 of the bracket 50 in the up and down direction. The closing member 60 is assembled onto a second end portion 50b of the bracket 50 from an opposite side (the upper side in FIG. 8) which is opposite, in the width direction of the support walls 52, 52, to the connecting wall 53 while the distal end portion 70a of each of the side plate portions 70, 70 serves as an insertion end. The closing member 60 of the embodiment is configured such that the side plate portions 70, 70 serving as the insertion portions 66, 66 are in slidably contact with the support walls 52, 52 of the bracket 50 during the assembling work. Accordingly, the closing member 60 is configured such that each of the side plate portions 70, 70 is inserted through the insertion holes 63a and 63b in a state where each of the distal end portions 70a, 70a fits in the insertion hole 63a of the first extended wall 62a provided at each of the support walls 52, 52 and each of the intermediate portions 70c, 70c fits in the insertion hole 63b of the second extended wall 62b.

As illustrated in FIGS. 7, 8 and 11, the bracket 50 of the embodiment includes a through hole 72 formed at each of the wide portions 58, 58 provided at the second end portions 52b, 52b of the support walls 52, 52 so as to penetrate the wide portions 58, 58 in a thickness direction. Each of the through holes 72 is positioned at a side which is opposite to the connecting wall 53 across the engagement hole 51 in the width direction of the wide portion 58, that is, each of the through holes 72 is positioned at a side from which the closing member 60 is assembled onto the bracket 50. The closing member 60 of the embodiment includes a through hole 73 formed at the base end portion 70b of each of the side plate portions 70, 70 so as to penetrate the side plate portion 70 in a thickness direction. The door check apparatus 20 of the embodiment is configured such that a fixing pin 74 is inserted into the through holes 72, 72 and the through holes 73, 73, and thus the closing member 60 is fixed to the support walls 52, 52 of the bracket 50 at which the engagement holes 51, 51 are provided, in a state where the closing member 60 closes the opening portions 57, 57 that are in communication with the engagement holes 51, 51.

In more detail, as illustrated in FIGS. 8, 10A and 11, the closing member 60 of the embodiment includes a curved surface 75 formed at a boundary portion between the distal end portion 70a and the intermediate portion 70c of each side plate portion 70 that is inserted through the insertion holes 63a and 63b of the first extended wall 62a and the second extended wall 62b. Each of the curved surfaces 75, 75 is formed to meet or follow along a peripheral surface of the engagement protrusion 40 positioned inside the engagement hole 51.

That is, the closing member 60 of the embodiment is arranged at a radially outer side of each of the engagement protrusions 40, 40 disposed in the engagement holes 51, 51 in a state where the distal end portion 70a of each of the side plate portions 70, 70 that is inserted through the insertion holes 63a and 63b of the first extended wall 62a and the second extended wall 62b is arranged so as to bridge between or be laid between the first extended wall 62a and the second extended wall 62b. The intermediate portion 70c of each of the side plate portions 70, 70 fits in the insertion hole 63b of the second extended wall 62b as stated above, and thus the curved surface 75 formed at the boundary between the intermediate portion 70c and the distal end portion 70a is arranged at the radially outer side of the engagement protrusion 40 disposed in the engagement hole 51 while the curved surface 75 is placed to follow the circumferential surface of the engagement protrusion 40. Thus, the door check apparatus 20 of the embodiment is configured such that the engagement protrusions 40, 40 of the outer tube 22 that are placed inside the respective engagement holes 51, 51 are supported, from the outer side in the radial direction of the engagement protrusions 40, 40, by the closing member 60 closing the opening portions 57, 57 that are in communication with the engagement holes 51, 51 and by the peripheral wall portions 61, 61 formed in the standing manner at the peripheral edges of the engagement holes 51, 51.

Next, effects obtained from the embodiment will be described. (1) According to the embodiment, the door check apparatus 20 includes the inner tube 21 (i.e., the first tubular member) connected to the vehicle body 2 to be pivotable relative to the vehicle body 2, the outer tube 22 (i.e., the second tubular member) arranged coaxially with the inner tube 21 in a state where the outer tube 22 is movable relative to the inner tube 21 in the axial direction, and the bracket 50 connecting the outer tube 22 to the swing door 10 in such a manner that the outer tube 22 is pivotable relative to the swing door 10. The outer tube 22 includes the pair of engagement protrusions 40, 40, the engagement protrusions 40, 40 are extended in the opposing directions that are opposite to each other in a state where the engagement protrusions 40, 40 are orthogonal to the axial line N of the outer tube 22, and the engagement protrusions 40, 40 form the pivot shaft L2 of the outer tube 22. The bracket 50 includes the pair of support walls 52, 52 including the engagement holes 51, 51 engaging with the engagement protrusions 40, 40. The bracket 50 includes the connecting wall 53 connecting the support walls 52, 52 to each other. Each of the support walls 52, 52 is provided with the opening portion 57 allowing the engagement protrusion 40 of the outer tube 22 to be inserted into the engagement hole 51 from the radial direction of the engagement hole 51, and the closing member 60 closing the opening portion 57, 57 in a state where the engagement protrusions 40, 40 are placed by insertion in the engagement holes 51, 51.

According to the above-described configuration, the bracket 50 can be fixedly attached to the vehicle body 2 in a state where the support walls 52, 52, each including the engagement hole 51 engaging with the engagement protrusion 40 of the outer tube 22, are integrated with each other by the connecting wall 53. Accordingly, with the simple configuration, the pivot shaft L2 of the outer tube 22 which is formed of the engagement protrusions 40, 40 arranged inside the respective engagement holes 51, 51 is easily restricted from being tilted and/or twisted, while a high assembling accuracy relative to the vehicle 2 is assured easily.

By using the opening portions 57, 57 provided at the support walls 52, 52, the engagement protrusions 40, 40 of the outer tube 22 can be easily inserted into the engagement holes 51, 51, respectively, from the radial direction of the holes. The engagement protrusions 40, 40 disposed in the engagement holes 51, 51 are restricted by the closing member 60 from performing the relative movement via the opening portions 57, 57, that is, restricted from coming out of the engagement holes 51, 51. Thus, the outer tube 22 is allowed to be connected to the swing door 10 via the bracket 50 while the stable pivot movement of the outer tube 22 is assured, thereby making the assembling work of the apparatus easy. Further, the bracket 50 is formed easily by performing plastic forming, including bending or folding process, on metal plate material, for example.

(2) According to the embodiment, each of the support walls 52, 52 includes the peripheral wall portion 61 provided at the peripheral edge of the engagement hole 51 in the standing manner. According to the above-described configuration, the engagement protrusions 40, 40, which form the pivot shaft L2 of the outer tube 22, are supported from the radially outer side of the engagement protrusions 40, 40 by the peripheral wall portions 61, 61 formed in the standing manner at the peripheral edges of the engagement holes 51, 51. Thus, the outer tube 22 is supported more stably in a state where the outer tube 22 is pivotable.

(3) According to the embodiment, each of the peripheral wall portions 61, 61 includes the first extended wall 62a and the second extended wall 62b which serve as the extended wall 62 provided in the extended manner at the peripheral edge of the opening portion 57 that is in communication with the engagement hole 51. The first extended wall 62a and the second extended wall 62b are provided with the insertion hole 63a and the insertion hole 63b, respectively. The insertion hole 63a and the insertion hole 63b serve as the insertion hole 63 into which the insertion portion 66 of the closing member 60 is inserted.

According to the above-described configuration, the opening portions 57, 57 are stably closed in a state where the closing member 60 is engaged at the peripheral wall portions 61, 61 provided in the standing manner at the peripheral edges of the engagement holes 51, 51 and the opening portions 57, 57. The closing member 60, which is arranged at the radially outer side of the engagement protrusions 40, 40 defining the pivot shaft L2 of the outer tube 22, can be positioned readily and accurately. Accordingly, the closing member 60 is allowed to support the engagement protrusions 40, 40 from the radially outer side, and thus the outer tube 22 is supported in a state of being pivotable in a more stable manner.

(4) According to the embodiment, the closing member 60 includes the pair of side plate portions 70, 70 each serving as the insertion portion 66 to be inserted into the insertion holes 63 (the insertion holes 63a and 63b) of the extended walls 62 (the first and second extended walls 62a and 62b) formed in the standing manner at the peripheral edge of each of the opening portion 57. Each of the side plate portions 70, 70 includes the curved surface 75 formed to follow along the peripheral surface of the engagement protrusion 40 positioned inside the engagement hole 51.

According to the above-described configuration, the closing member 60 arranged at the radially outer side of the engagement protrusions 40, 40 supports the engagement protrusions 40, 40 appropriately. Thus, the outer tube 22 is supported more stably in a state where the outer tube 22 is pivotable.

(5) According to the embodiment, the door check apparatus 20 includes the spindle screw 23 rotatably supported by the bearing 25 provided at the outer tube 22 in a state where the spindle screw 23 is arranged to be coaxial with the inner tube 21 and the outer tube 22, and the spindle nut 24 fixed to the inner tube 21 not to be rotatable relative to the inner tube 21 in a state where the spindle nut 24 is threadedly engaged with the spindle screw 23. The door check apparatus 20 includes the electromagnetic brake 30 serving as the brake apparatus which applies the braking force to the spindle screw 23 rotating as the inner tube 21 and the outer tube 22 move relative to each other in the axial direction.

At the door check apparatus 20 including the above configuration, the inner tube 21 and the outer tube 22, and the spindle screw 23 are desired to be coaxial with one another to assure a smooth action or operation. Accordingly, the configuration is appropriate in which the pair of engagement protrusions 40, 40 extended in the opposite directions to each other and being orthogonal to the axial line N of the outer tube 22 is provided at the outer tube 22, and the engagement protrusions 40, 40 form the pivot shaft L2 of the outer tube 22. Consequently, with the above-described configurations (1) to (4), the door check apparatus 20 may obtain even more remarkable effects.

The aforementioned embodiment can be implemented with the following modifications and/or changes. The aforementioned embodiment and the variations described below can be combined with each other and implemented within a range that does not cause any technical conflicts.

In the aforementioned embodiment, the door check apparatus 20 configured to be mounted on the swing door 10 including the configuration of the side door of the vehicle 1 is embodied. The embodiment is, however, also applicable to the door check apparatus 20 configured to be mounted on the swing door 10 of different types, including a back door of a so-called hinged double doors or biparting double doors, for example.

In the aforementioned embodiment, the inner tube 21 serving as the first tubular member is connected to the vehicle body 2 and the outer tube 22 serving as the second tubular member is connected to the swing door 10 via the bracket 50. However, the configuration is not limited thereto and the outer tube 22 may serve as the first tubular member and be connected to the vehicle body 2 and the inner tube 21 may serve as the second tubular member and be connected to the swing door 10 via the bracket 50. The first tubular member and the second tubular member do not need to overlap each other in the radial direction as long as the configuration includes the first tubular member connected to the vehicle body to be pivotable relative to the vehicle body 2, the second tubular member connected to the first tubular member to be movable in the axial direction relative to the first tubular member, and the bracket connecting the second tubular member to the swing door in such a manner that the second tubular member is pivotable relative to the swing door. At least either one of the first tubular member and the second tubular member may be replaced by a shaft member including a shape of a shaft.

A configuration is applicable in which the bearing 25 is provided at the inner tube 21 and the spindle nut 24 is provided at the outer tube 22. A configuration is applicable in which the electromagnetic brake 30 may be provided integrally with the inner tube 21.

The braking mechanism that gives the door check apparatus 20 the braking function of the swing door 10 may be arbitrarily changed. For example, the braking mechanism does not need to include the spindle screw 23 and/or the spindle nut 24. The above-described connecting structure of connecting the door check apparatus to the sing door 10 and a structure similar thereto are also applicable to a door check apparatus which does not include the above-stated braking mechanisms.

In the aforementioned embodiment, each of the opening portions 57, 57 that are in communication with the engagement holes 51, 51 opens in the lengthwise direction of the support walls 52, 52. However, the opening portions 57, 57 may open in the width direction of the support walls 52, 52 as long as the closing member 60 closes the opening portions 57, 57 so that the engagement protrusions 40, 40 placed inside the engagement holes 51, 51 do not come off the engagement holes 51, 51. In this case, a shape and configuration of the closing member 60 may be arbitrarily changed.

In the aforementioned embodiment, each of the support walls 52, 52 is provided with the opening portion 57 that is in communication with the engagement hole 51. The opening portion 57, however, may be provided at either one of the support walls 52, 52. Even in such a configuration, the outer tube 22 is assembled onto the bracket 50 easily by, for example, tilting the outer tube 22.

The peripheral wall portion 61 formed in the standing manner at the peripheral edge of each of the engagement holes 51, 51 may be provided at either one of the support walls 52, 52. Further, a configuration in which none of the support walls 52, 52 is provided with the peripheral wall portion 61 is also applicable.

In the aforementioned embodiment, the first extended wall 62a and the second extended wall 62b are provided in the standing manner at the peripheral edge of each of the opening portions 57, 57, and the first extended wall 62a and the second extended wall 62b oppose each other over the opening portion 57. Further, the insertion holes 63a and 63b are provided at the first extended wall 62a and the second extended wall 62b, respectively, so as to penetrate the walls in the thickness direction in such a manner that the insertion holes 63a and 63b are positioned to oppose each other. The closing member 60 includes the pair of side plate portions 70, 70 each serving as the insertion portion 66 configured to be inserted into the insertion holes 63a and 63b, and the standing plate portion 71 connecting the side plate portions 70, 70 to each other, and accordingly, the outer shape of the closing member 60 includes the cross section of substantially U-shape or three-sided rectangular shape.

However, the configuration is not limited thereto and a configuration is also applicable in which the side plate portions 70, 70 serving as the insertion portions 66, 66 of the closing member 60 are not connected to each other with the use of the standing plate portion 71, for example. Either one of the first extended wall 62a and the second extended wall 62b may be provided as the extended wall 62, and the insertion portion 66 of the closing member 60 may be inserted into the insertion hole 63 provided at the extended wall 62. A configuration is applicable in which the extended wall 62 is not provided at the peripheral edge of the opening portion 57. Then, the opening portion 57 may be configured to be closed by fixing the closing member 60 to the bracket 50.

In the aforementioned embodiment, the insertion hole 63a of the first extended wall 62a and the insertion hole 63b of the second extended wall 62b include the widths that differ from each other, however, the width of the insertion hole 63a and the width of the insertion hole 63b may be same as each other.

In the aforementioned embodiment, the closing member 60 includes the curved surface 75 formed to follow along or to meet the peripheral surface of the engagement protrusion 40 placed inside the engagement hole 51, however, a configuration in which the curved surface 75 is not provided is applicable.

In the aforementioned embodiment, the fixing pin 74 is inserted in the through holes 72, 72 formed at the support walls 52, 52 of the bracket 50 and in the through holes 73, 73 formed at the side plate portions 70, 70 of the closing member 60, and thus the closing member 60 is securely fastened to the support wall 52, 52 of the bracket 50. However, the fastening configuration of the closing member 60 is not limited to a particular structure and may be arbitrarily changed to a configuration using other fastening member including a bolt, for example.

According to the aforementioned embodiment, the door check apparatus for a vehicle includes the inner tube 21 (i.e., the first tubular member) configured to be connected to the vehicle body 2 to be pivotable relative to the vehicle body 2, the outer tube 22 (i.e., the outer tube 22) arranged coaxially with the inner tube 21 in a state where the outer tube 22 is movable relative to the inner tube 21 in the axial direction, and the bracket 50 configured to connect the outer tube 22 to the swing door 10 in such a manner that the outer tube 22 is pivotable relative to the swing door 10. The outer tube 22 includes the pair of engagement protrusions 40, 40, the engagement protrusions 40, 40 are extended in the opposing directions that are opposite to each other in a state where the engagement protrusions 40, 40 are orthogonal to the axial line N of the outer tube 22, and the engagement protrusions 40, 40 form the pivot shaft L2 of the outer tube 22. The bracket 50 includes the pair of support walls 52, 52 provided to oppose each other. The support walls 52, 52 include the engagement holes 51, 51 engaging with the engagement protrusions 40, 40, and the connecting wall 53 connecting the support walls 52, 52 to each other. At least one of the support walls 52, 52 is provided with the opening portion 57 allowing one of the engagement protrusions 40, 40 to be inserted into one of the engagement holes 51, 51 from the radial direction of the engagement hole 51, and the closing member 60 closing the opening portion 57 in a state where the engagement protrusion 40 is inserted in the engagement hole 51.

According to the above-described configuration, the bracket 50 can be fixedly attached to the vehicle body 2 in a state where the support walls 52, 52 each including the engagement hole 51 engaging with the engagement protrusion 40 are integrated with each other by the connecting wall 53. Accordingly, with the simple configuration, the pivot shaft L2 of the outer tube 22 which is formed of the engagement protrusions 40, 40 arranged in the respective engagement holes 51, 51 is easily restricted from being tilted and/or twisted while a high assembling accuracy relative to the vehicle 2 is assured easily.

By using the opening portion 57 provided at at least one of the support walls 52, 52, the engagement protrusions 40, 40 of the outer tube 22 can be readily inserted into the corresponding engagement holes 51, 51 from the radial direction of the holes 51, 51. The engagement protrusions 40, 40 disposed by insertion in the engagement holes 51, 51 that are in communication with the opening portions 57, 57 are restricted by the closing member 60 from performing the relative movement via the opening portions 57, 57, that is, restricted from acting to come out of the engagement holes 51, 51. Thus, the outer tube 22 is allowed to be connected to the swing door 10 via the bracket 50 while the stable pivotal movement of the outer tube 22 is assured, thereby making the assembling work of the apparatus easy.

According to the aforementioned embodiment, at least one of the support walls 52, 52 includes the peripheral wall portion 61 provided at the peripheral edge of the engagement hole 51 in the standing manner.

According to the above-described configuration, the engagement protrusion 40, 40 forming the pivot shaft L2 of the outer tube 22 are supported from the outer side in the radial direction by the peripheral wall portion 61 formed in the standing manner at the peripheral edge of the engagement hole 51. Thus, the outer tube 22 is supported more stably in a state where the outer tube 22 is pivotable.

According to the aforementioned embodiment, the peripheral wall portion 61 formed at the support wall 52 which is provided with the opening portion 61 includes the extended wall 62, 62a, 62b provided at the peripheral edge of the opening portion in the extended manner, and the extended wall 62, 62a, 62b is provided with the insertion hole 63, 63a, 63b into which the closing member 60 is inserted.

According to the above-described configuration, the opening portion 57 is stably closed in a state where the closing member 60 is engaged with the peripheral wall portion 61 formed in the standing manner at the peripheral edges of the engagement hole 51 and the opening portion 57. Further, the closing member 60, which is arranged at the radially outer side of the engagement protrusions 40, 40 defining the pivot shaft L2 of the outer tube 22, can be positioned easily and accurately. Accordingly, the closing member 60 can supports the engagement protrusions 40, 40 from the radially outer side, and thus the outer tube 22 is supported even more stably in a state where the outer tube 22 is pivotable.

According to the aforementioned embodiment, the closing member 60 includes the curved surface 75 formed to follow along the peripheral surface of the engagement protrusion 40.

According to the above-described configuration, the closing member 60 arranged at the radially outer side of the engagement protrusion 40 supports the engagement protrusion 40 appropriately. Thus, the outer tube 22 is supported more stably in a state where the outer tube 22 is pivotalbe.

According to the aforementioned embodiment, the door check apparatus 20 includes the spindle screw 23 rotatably supported by the bearing 25 provided at one of the inner tube 21 and the outer tube 22 in a state where the spindle screw 23 is arranged to be coaxial with the inner tube 21 and the outer tube 22, the spindle nut 24 fixed to the other of the inner tube 21 and the outer tube 22 not to be rotatable relative to the other of the inner tube 21 and the outer tube 22 in a state where the spindle nut 24 is threadedly engaged with the spindle screw 23, and the electromagnetic brake 30 (i.e., the brake apparatus) configured to apply the braking force to the spindle screw 23 rotating due to the relative movement of the inner tube 21 and the outer tube 22 relative to each other.

At the door check apparatus 20 including the above configuration, the inner tube 21 and the outer tube 22, and the spindle screw 23 are desired to be coaxial with one another to assure smooth action or operation. Accordingly, it is appropriate that the pair of engagement protrusions 40, 40 extended in the opposite directions to each other and being orthogonal to the axial line N of the outer tube 22 is provided at the outer tube 22, and the engagement protrusions 40, 40 form the pivot shaft L2 of the outer tube 22. Consequently, with the above-described configurations, the door check apparatus 20 may obtain even more remarkable effects.

According to the disclosure, the assembling work of the door check apparatus 20 can be made easy.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door check apparatus for a vehicle, the apparatus comprising:
a first tubular member configured to be connected to a vehicle body to be pivotable relative to the vehicle body;
a second tubular member arranged coaxially with the first tubular member in a state where the second tubular member is movable relative to the first tubular member in an axial direction;
a bracket configured to connect the second tubular member to a swing door in such a manner that the second tubular member is pivotable relative to the swing door;
the second tubular member including a pair of engagement protrusions, the engagement protrusions extended in opposing directions that are opposite to each other in a state where the engagement protrusions are orthogonal to an axial line of the second tubular member, the engagement protrusions forming a pivot shaft of the second tubular member;
the bracket including:
a pair of support walls provided to oppose each other, the support walls including engagement holes engaging with the engagement protrusions, and
a connecting wall connecting the support walls to each other; and
at least one of the support walls being provided with:
an opening portion allowing one of the engagement protrusions to be inserted into one of the engagement holes from a radial direction of the engagement hole, and
a closing member closing the opening portion in a state where the engagement protrusion is inserted in the engagement hole.

2. The door check apparatus for a vehicle according to claim 1, wherein at least one of the support walls includes a peripheral wall portion provided at a peripheral edge of the engagement hole in a standing manner.

3. The door check apparatus for a vehicle according to claim 2, wherein
the peripheral wall portion formed at the support wall which is provided with the opening portion includes an extended wall provided at a peripheral edge of the opening portion in an extended manner, and
the extended wall is provided with an insertion hole into which the closing member is inserted.

4. The door check apparatus for a vehicle according to claim 1, wherein the closing member includes a curved surface formed to follow along a peripheral surface of the engagement protrusion.

5. The door check apparatus for a vehicle according to claim 1, the apparatus comprising:
a spindle screw rotatably supported by a bearing provided at one of the first tubular member and the second tubular member in a state where the spindle screw is arranged to be coaxial with the first tubular member and the second tubular member;
a spindle nut fixed to the other of the first tubular member and the second tubular member not to be rotatable relative to the other of the first tubular member and the second tubular member in a state where the spindle nut is threadedly engaged with the spindle screw; and
a brake apparatus configured to apply a braking force to the spindle screw rotating due to the relative movement of the first tubular member and the second tubular member relative to each other.
